(19) United States
(12) Patent Application Publication
(10) Pub. No.: US 2015/0282664 A1
(43) Pub. Date: Oct. 8, 2015

(54) BEVERAGE POD PRESS

(71) Applicants: Michael C. Savage, Santa Barbara, CA (US); Erik Savage, Santa Barbara, CA (US)

(72) Inventors: Michael C. Savage, Santa Barbara, CA (US); Erik Savage, Santa Barbara, CA (US)

(21) Appl. No.: 14/246,323

(22) Filed: Apr. 7, 2014

(51) Int. Cl. A47J 31/38; A23F 5/26; A23F 3/18; A47J 31/40

(52) U.S. Cl. CPC A47J 31/38; A47J 31/407; A23F 5/262; A23F 3/18

(57) ABSTRACT

An improved coffee brewing system is presented that uses commercially-available beverage cups in a unique way. Instead of forcing liquid through the beverage cup, the present invention forces the beverage cup through the liquid. The mechanism of the invention itself is simple to make and use, and requires no electric power.

### RELATED APPLICATIONS

This application claims the benefit of U.S. Provisional Patent Application 61/941,465, filed Feb. 18, 2014, whose content is included here by reference.

### FIELD OF THE INVENTION

The field of this invention is the technology of beverage brewing, particularly the art of portable coffee containers, portable coffee brewers, and automatic coffee brewers.

### BACKGROUND OF THE INVENTION

Many versions of single-cup beverage brewing devices exist, but to the inventor's knowledge, they all work by forcing pressurized liquid through a stationary beverage pod. For example, US Pat. Appl. No. 2012/0260806 to Rolfes, et al., and US Pat. Appl. No. 2013/0213240 to O'Brien are distinguishable from this invention. In addition US Pat. Appls. 2010/0116143 to Cerroni and 2011/0056385 to McLean have features that are comparable to the present invention, but differ in manufacturability as well as other issues. U.S. Pat. Nos. 8,313,644 to Harris and 7,213,507 to Glucksman, et al., are also background to this invention.

### SUMMARY OF THE INVENTION

State of the art pod coffee brewers use the technique of forcing hot brewing water through a punctured coffee pod to make coffee in a single-cup mode. The present invention flips the single-cup brewing paradigm and forces the beverage pod to travel through the liquid.

The result is the same, a beverage is brewed as a liquid is infused with beverage medium during the water's passage through the brewing pod. All the advantages of the single-cup brewing devices are still retained, with the added advantages of substantially fewer parts, substantially lower device cost, and the brewed beverage resides, and can be consumed from the same vessel.

The invention is a portable, single-cup, beverage brewing device that uses conventional beverage “pods” to infuse liquid with flavoring. A plunger-actuated receptacle holds, pierces and encloses the pod, which is then forced by hand in a piston-like fashion, through liquid in a liquid-tight vessel, forcing the liquid through the receptacle and pod, to create a brewed liquid.

The invention, in its entirety, is a piston-like, holding device that captures, encloses and punctures various, single-serve, beverage pods in the field of the art and/or captures and encloses refillable pods, and forces those pods to travel through liquid constrained in a liquid-tight cylinder. The holding device has an integral, liquid-tight seal (lip-seal, or ‘O’-Ring, or snug-fitting flexible material) that allows the holding device to travel vertically inside a tubular, water-tight vessel. The holding device is composed of a receptacle that holds various pods and an outer cylinder that function together like a piston in a cylinder. The user inserts a beverage pod into the receptacle and secures it with a screw-on lid. The action of inserting and securing the pod punctures the pod, both top and bottom, and secures it in the same motion. The ring seals on the receptacle cap are dimensioned to slide within the tubular, water-tight vessel and create a pressure-forming, frictional fit between the receptacle and the inside walls of the vessel.

Thus, when the pod-loaded receptacle is pushed into the liquid-filled outer cylinder, the liquid is pressurized and forced to pass through one end of the receptacle and the punctured pod and emerge from the other end as a brewed liquid residing above the receptacle in the vessel, where it can be poured into a drinking vessel, or drunk directly from the cylinder.

The invention thereby produces a brewed beverage, e.g. coffee, tea, broths, etc. from various commercially available beverage pods.

### BRIEF DESCRIPTION OF THE FIGURES

FIG. 1. Exploded view of the invention

FIG. 2. Side view of the invention

FIG. 3. Cross-section view of the assembled invention in use

### DETAILED DESCRIPTION

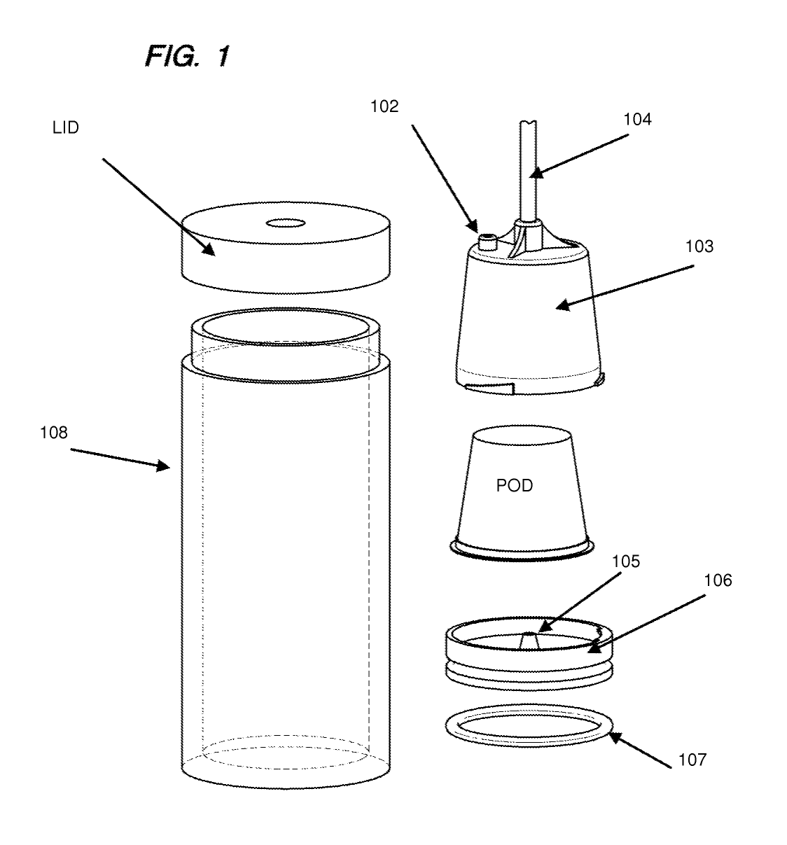

As in FIG. 1, the invention consists of two major components, the caddy and the water tight vessel 108. The caddy consists of four parts: metal plunger rod 104, pod-receiving receptacle 103 with a sharpened, hollow “piercing” outlet tube 102, screw on cap 106, with sharpened hollow “piercing” inlet tube 105, and a flexible ring-seal 107 encircling the caddy cap, and forming the pressure seal between caddy and water-tight vessel 108.

The water-tight vessel is comprised of a firm material, selected from the list of plastic, metal, glass, or ceramic It is a cylindrical structure with straight interior walls and flat bottom.

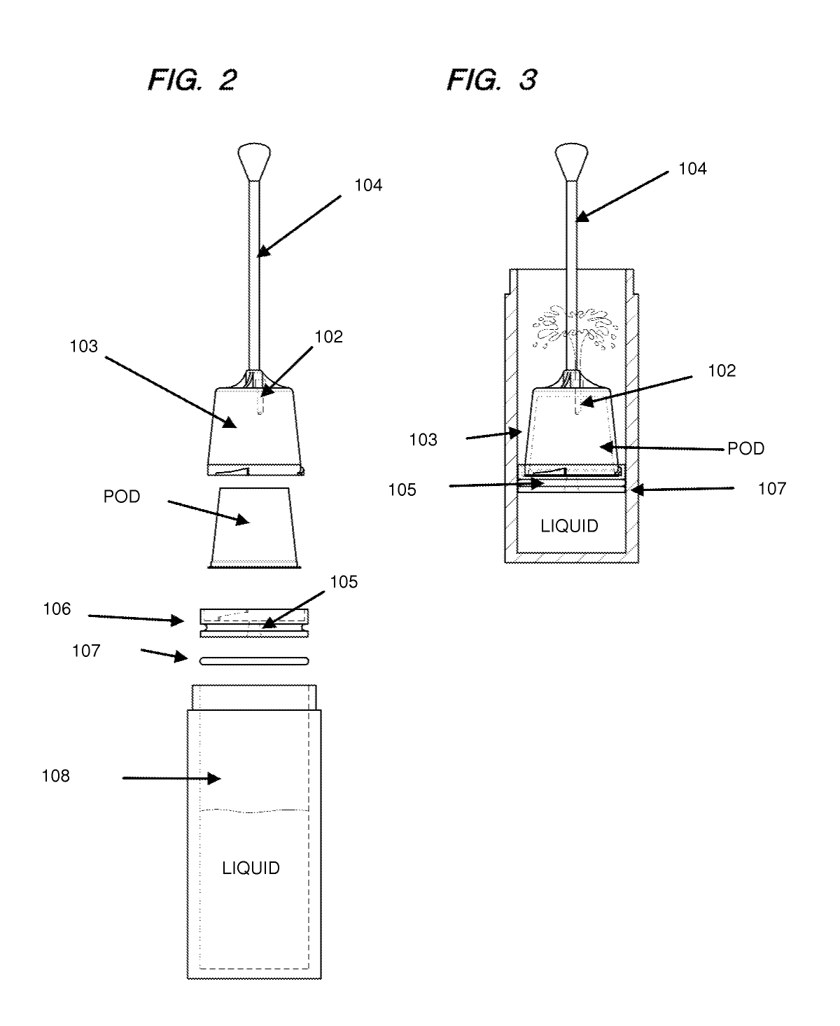

The method of operation of the invention is comprised of the following steps, as shown in FIG. 2 and FIG. 3:

### Phase 1

The pod is inserted into pod-receiving receptacle 103, piercing out-flow tube 102 pierces bottom of pod, the screw-on Cap 106 is twisted onto the pod-receiving receptacle 103 capturing the pod, and piercing in-flow tube 105 pierces the top of the pod.

### Phase 2

Liquid is poured into water-tight vessel 108, the caddy assembly with beverage pod is inserted into water-tight vessel 108, the liquid is pressurized through the caddy when the plunger rod 104 is forced downward and the flexible ring seal 107 keeps liquid from passing between cylinder and the screw-on cap 106.

### Phase 3

As the caddy moves downward, liquid is forced upward through the piercing in-flow tube 105, and thereby through the pod and beverage medium inside it, infusing the liquid. Finally, liquid is forced through the piercing out-flow tube 102 and enters top chamber of water-tight vessel 108, User sips from vessel or transfers brewed beverage to another vessel.

This invention is not to be limited to the embodiments described in the description which are given by way of example and not of limitation, but only in accordance with the scope of the appended claims.

What is claimed is:

1. A beverage press system, the beverage press system comprised of a pod caddy and a water tight vessel,
the pod caddy consisting of a plunger rod, a concave pod receiver with a sharpened, hollow outlet tube extending from the closed upper surface of said pod receiver down into the interior of said pod receiver, a screw on cap with a sharpened inlet tube penetrating said screw on cap and extending from the upper surface of said screw on cap, and a flexible seal encircling the screw on cap,
the plunger rod attached fixedly to the closed upper surface of said pod receiver, the plunger rod comprised of a material selected from the list of aluminum, steel, or dense plastic,
the water tight vessel comprised of a hollow, cylindrical structure comprised of a rigid material selected from the list of plastic, metal, glass, or ceramic, said structure with straight interior walls and flat circular bottom.

2. A beverage press system as in claim 1 where a lid is provided that fits removably over the open top of the water tight vessel and where said lid has a centrally-located hole passing through it that fits the shaft of the plunger rod.

3. A method of using a beverage press system as in claim 1 comprised of the steps of
a) inserting a beverage pod into the pod receiver,
b) piercing the bottom of the pod with the out flow tube,
c) twisting the screw on cap onto the pod receiver thereby puncturing the top of the pod with the in flow tube,
d) pouring liquid into the water tight vessel,
e) inserting the pod receiver assembly with beverage pod into the water tight vessel,
f) pressurizing the liquid through the pod receiver by forcing the plunger rod downward ,
g) forcing the liquid through the piercing in-flow tube and thereby through the pod and beverage medium inside it, infusing the liquid,
h) forcing the liquid hence through the piercing out flow tube and into the empty top chamber of the water-tight vessel.
